(19) United States
(12) Patent Application Publication
(10) Pub. No.: US 2007/0044242 A1
(43) Pub. Date: Mar. 1, 2007

(54) PROVIDING MOBILITY SUPPORT

(76) Inventor: Patricia M. Banks, Bellevue, WA (US)

Correspondence Address: JARDINE LAW OFFICES, 116 129TH AVENUE NE, BELLEVUE, WA, 98005, US

(21) Appl. No.: 11/462,820

(22) Filed: Aug. 7, 2006

Related U.S. Application Data
(60) Provisional application No. 60/713,389, filed on Sep. 1, 2005.

(51) Int. Cl. A61G 7/10

(52) U.S. Cl. 5/662; 5/81.1 R

(57) ABSTRACT

Aspects of the subject matter described herein relate to providing mobility support to assist people in maneuvering. In aspects, a support structure is coupled to a base to secure the support structure in an upstanding position. A grab bar is coupled to the support structure. When the grab bar is lifted substantially vertically from the support structure, the grab bar may be decoupled from the support structure. When the grab bar is lifted such that a horizontal component of force is applied against the support structure, the grab bar resists decoupling from the support structure. Other aspects are described in the Detailed Description.

### CROSS REFERENCE TO RELATED APPLICATION

This application claims the benefit of U.S. Provisional Application No. 60/713,389, filed Sep. 1, 2005, entitled SYSTEMS, APPARATUS, AND METHODS RELATED TO BED MOBILITY DEVICES which application is incorporated herein in its entirety.

### BACKGROUND

As people get older, they are more susceptible to serious injuries that result from falling. In the United States and many other modern countries with aging populations, falls are a leading cause of death in older people. Most fatal falls occur while traversing uneven ground such as steps, curbs, and other uneven surfaces. Falls associated with bed use (e.g., getting in and out of bed) are the second most common cause of death.

### SUMMARY

Briefly, aspects of the subject matter described herein relate to providing mobility support to assist people in maneuvering. In aspects, a support structure is coupled to a base to secure the support structure in an upstanding position. A grab bar is coupled to the support structure. When the grab bar is lifted substantially vertically from the support structure, the grab bar may be decoupled from the support structure. When the grab bar is lifted such that a horizontal component of force is applied against the support structure, the grab bar resists decoupling from the support structure.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a view generally illustrating an exemplary device for providing support for mobility in accordance with aspects of the subject matter described herein;

FIG. 2A-2C are views illustrating some exemplary components that allow a grab bar of a support device to rotate in accordance with aspects of the subject matter described herein;

FIG. 3 illustrates another embodiment of a supporting device according to aspects of the subject matter described herein;

FIGS. 4A-4D are views illustrating some exemplary components that may be used to restrict the range of rotation of a grab bar in accordance with aspects of the subject matter described herein;

FIG. 5A is a view illustrating another embodiment of a mobility support device in accordance with aspects of the subject matter described herein;

FIG. 5B is a cross-sectional view taken along the line 5B-5B of FIG. 5A;

FIGS. 6A and 6B are views that illustrate a mobility device having a bi-stable hinge in accordance with aspects of the subject matter described herein;

FIGS. 6C and 6D are views that illustrate a mobility device having a hinge with a single stable resting point in accordance with aspects of the subject matter described herein;

FIGS. 7A-7C are views that illustrate some embodiments in which additional stability may be provided to the support device in accordance with aspects of the subject matter described herein;

FIGS. 8A-8F are views that illustrate exemplary embodiments for adjusting the height of the grab bar in accordance with aspects of the subject matter described herein;

FIG. 9A illustrates a support device that includes a table and a grab bar in accordance with aspects of the subject matter described herein;

FIG. 9B illustrates a two bar embodiment of a support device in accordance with aspects of the subject matter described herein;

FIG. 9C illustrates another two bar embodiment of a support device in accordance with aspects of the subject matter described herein;

FIG. 10A illustrates a grab bar variation in accordance with aspects of the subject matter described herein;

FIG. 10B illustrates another grab bar variation in accordance with aspects of the subject matter described herein; and

FIGS. 11A and 11B illustrate an exemplary docking base according to aspects of the subject matter described herein.

### DETAILED DESCRIPTION

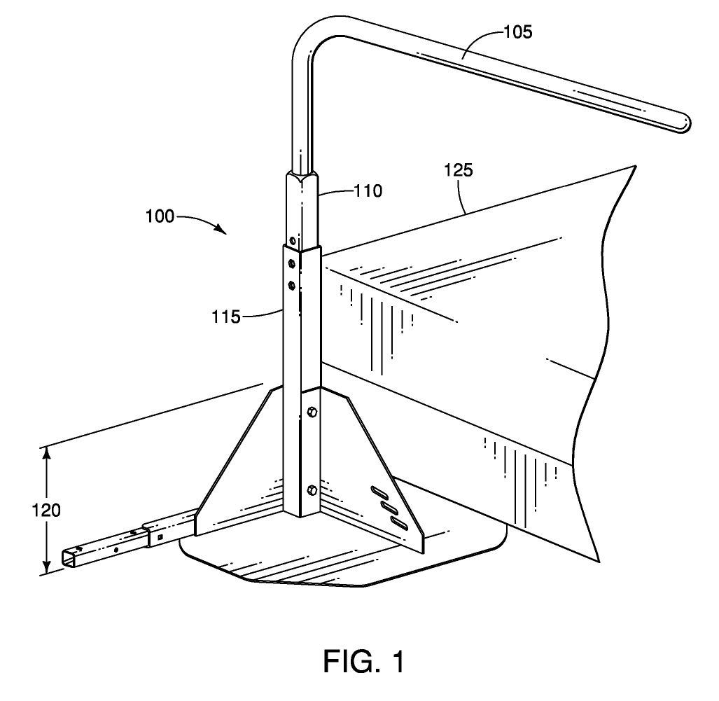

FIG. 1 is a view generally representing an exemplary device for providing support for mobility in accordance with aspects of the subject matter described herein. As illustrated, the support device 100 is shown next to a bed 125. The bed 125 may be an electric or non-electric bed, a water bed, an air bed, or any other type of bed designed for people to sleep or rest on. In an embodiment, the support device 100 is designed specifically for use in home bed applications. In other embodiments, the support device 100 is designed specifically for use in hospital bed applications. In yet other embodiments, the support device 100 is designed for use in home and hospital bed applications.

In other embodiments, the support device 100 may be installed next to a couch, chair, table, shower or tub, counter, or other location at which support may be needed. In an embodiment, the support device 100 may include a grab bar 105, a sleeve 110, a stand 115, and a base 120.

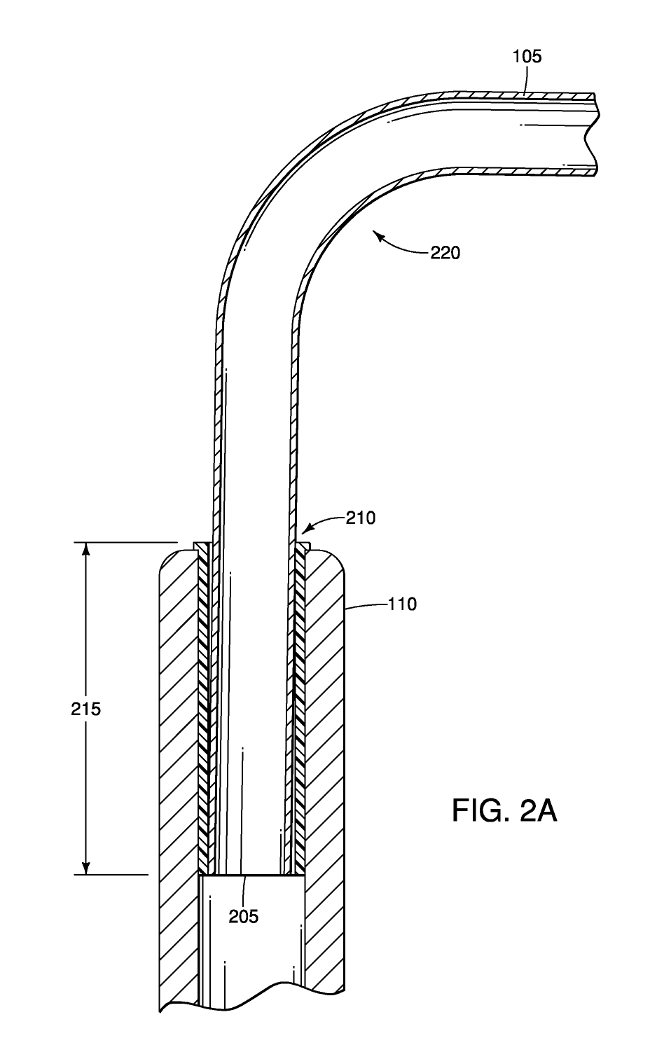

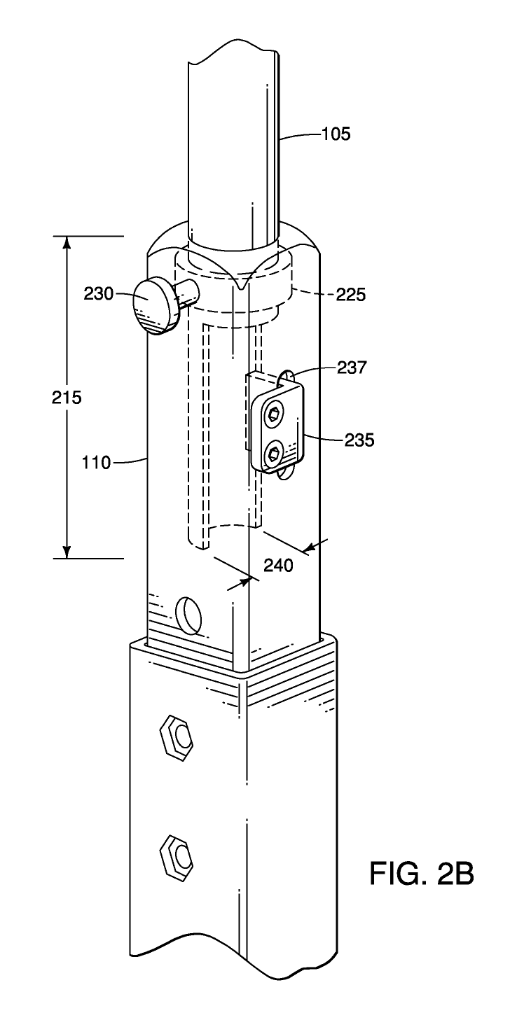

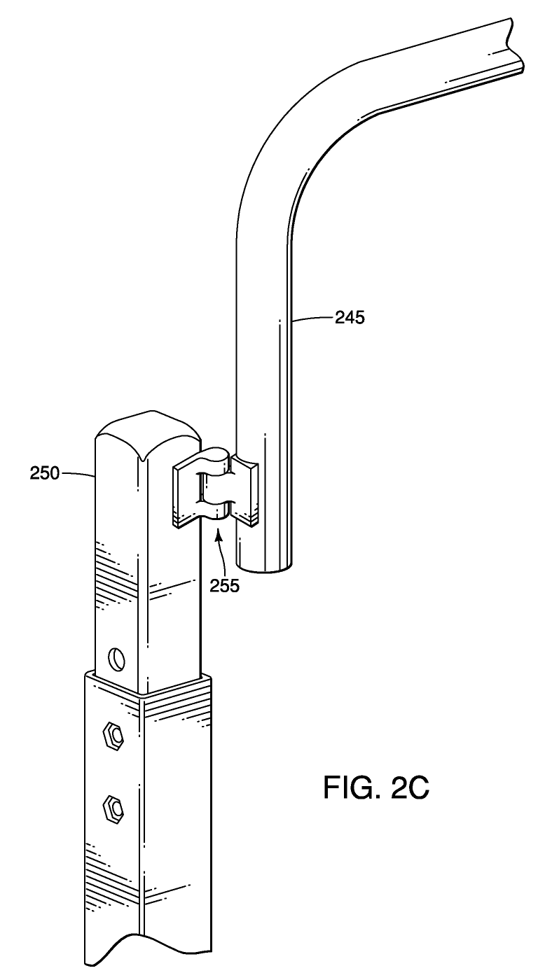

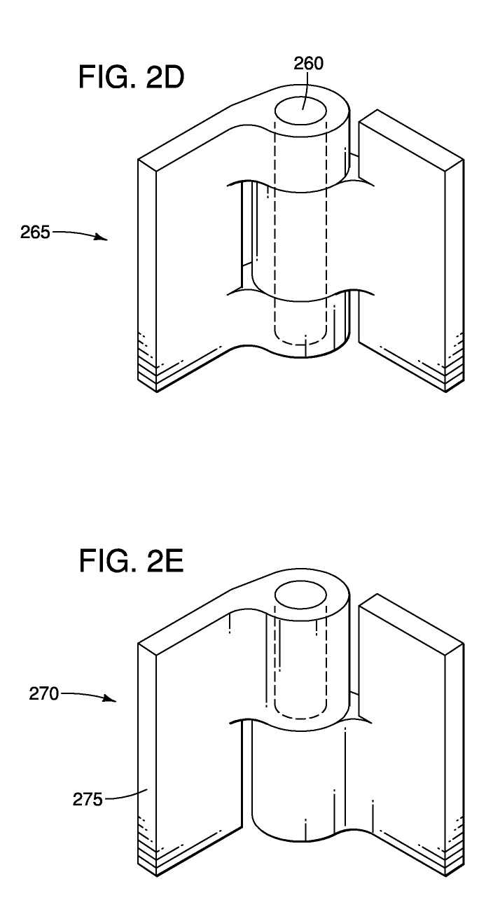

In operation, someone lying on the bed 125 may grab the grab bar 105 to provide support for sitting up or otherwise maneuvering on the bed 125. The person may also use the grab bar 105 for support in getting into or out of the bed 125. In some embodiments, through mechanisms described in more detail in conjunction with FIGS. 2B, 4A-4D, 5A and 5B, and other FIGURES, the grab bar 105 may be secured rotationally so as to remain parallel to the bed 125 while it is being used for support. In one embodiment, the mechanisms that restrict rotation of the grab bar 105 may comprise one or more keys. A person using the support device 100 may allow rotation of the grab bar 105 by removing or unlocking one or more of the keys and may restrict rotation by installing or locking one or more of the keys. The person may use these keys to allow the grab bar 105 to rotate within the sleeve 110 to provide support while the person moves away from the bed 125. In at least some embodiments, the grab bar 105 may rotate (e.g., pivot) freely without needing to be lifted.

As described in more detail in conjunction with FIGS. 2A-2E, the support device 100 may be structured to allow for easy removal of the grab bar 105. This may help in avoiding entrapment issues that other support devices may have. In entrapment, a person using a support device becomes trapped by the support device and may be unable to free him or herself. Entrapment can lead to death or injury.

In one embodiment, the base 120 of the support device 100 may be structured to be assembled using reconfigurable parts such that the support device 100 may be placed on the left, right, or near or at the center of the head of the bed 125. The grab bar 105 may be removed or rotated to be parallel or perpendicular to the head of the bed 125 when not in use. In an embodiment, a plurality of the support devices 100 may be placed on the left, right, and/or near the center of the head of the bed 125 in conjunction with providing bed mobility support.

Turning to FIG. 2A, in one embodiment, the bottom of the grab bar 105 may rest on a surface 205 within the sleeve 110. The grab bar 105 and the sleeve 110 may be structured such that the grab bar 105 remains in (e.g., is coupled to) the sleeve 110 until the grab bar 105 is lifted substantially straight out of the sleeve 110. As can be seen in FIG. 2A, the receiving hole 210 of the sleeve 110 may be formed to be slightly larger in diameter than the outer diameter of the sleeve 110. The weight of the grab bar 105's handle may cause the inserted portion 215 of the grab bar 105 to form a slight angle from vertical within the sleeve 110. It has been found that this arrangement causes the grab bar 105 to resist removal (e.g., decoupling) from the sleeve 110 as long as the inserted portion 215 continues to exert a horizontal force against the sides of the sleeve 110. When, however, the grab bar 105 is lifted substantially vertically near the curve 220 of the grab bar 105, it is relatively easy to remove the grab bar 105 from the sleeve 110.

In one embodiment, it is believed that the resistance to removal results from frictional and gravity forces. For example, when an upward force that tends to pull the grab bar 105 substantially vertical is greater than frictional and gravity forces associated with the grab bar 105, the grab bar 105 may be removed from the sleeve 110.

Additional weight or upward pull along the length of the grab bar 105 that generates a component of force not parallel to the sleeve 110 may cause the grab bar portion 215 within the sleeve 110 to increase its resistance to vertical movement, thus providing an effective mechanism that stops the accidental removal of the grab bar 105 from the sleeve 110. For example, if a person using the grab bar 105 to get out of bed is unstable and yanks downward or upward on the grab bar 105, the yanking will not in most cases be such to remove the grab bar 105 from the sleeve 110. Rather, the yanking will, in most cases, cause a component of force not parallel to the sleeve 110 to increase the sleeve 110's resistance to vertical movement and avoid removal of the grab bar 105 from the sleeve 110.

Turning to FIG. 2B, the sleeve 110 may include a washer 225 and a screw 230 that may also be used to provide resistance to both upward and rotational movement of the grab bar 105. The washer 225 may be sized to be substantially in contact with a portion of the grab bar 105 inserted into the sleeve. In one embodiment, tightening or loosening the screw 230 causes the washer 225 to press more or less firmly against the grab bar 105 thus causing more or less resistance to upward and rotational movement of the grab bar 105. In another embodiment, the screw 230 may be used to contract or expand the inner diameter of the washer 225 to cause the washer 225 to provide more or less resistance to upward and rotational movement of the grab bar 105.

A key 235 may be inserted through an opening 237 in the side of the sleeve 110 to restrict the range of rotational movement of the grab bar 105. The grab bar portion 215 inserted into the sleeve 110 may have a slot 240 cut out therein. The sides of the slot 240 may engage with the key 235 to restrict rotational movement of the grab bar 105 to a selected range. By varying the width of the slot 240 of the grab bar 105, the range of rotation allowed by the key 235 may be changed. For example, a relatively thin slot may allow relatively little rotation of the grab bar 105 while a relatively wide slot may allow proportionally larger rotation of the grab bar 105.

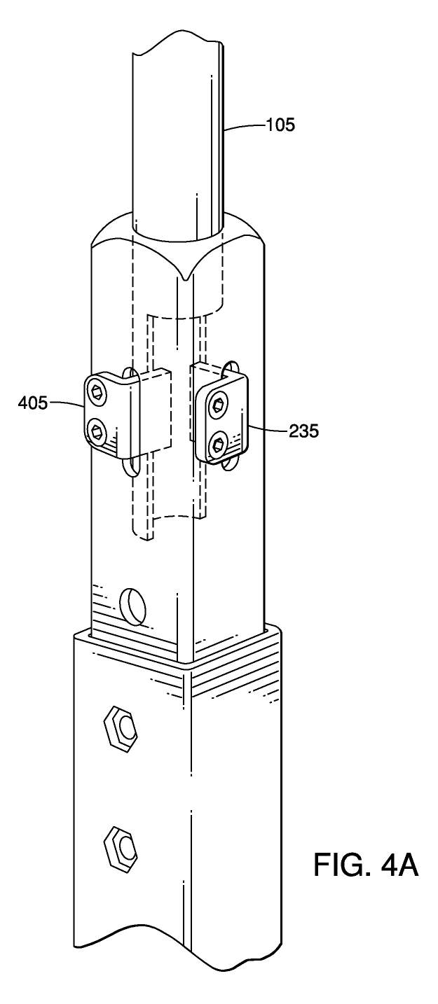

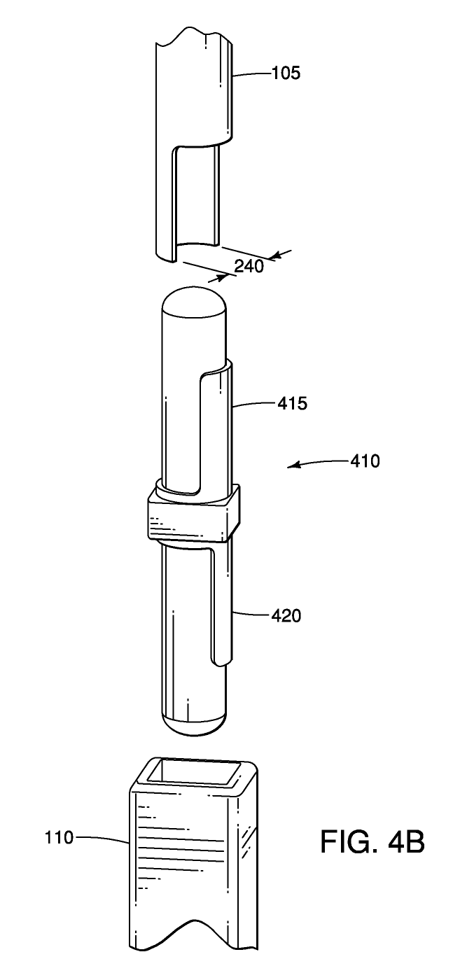

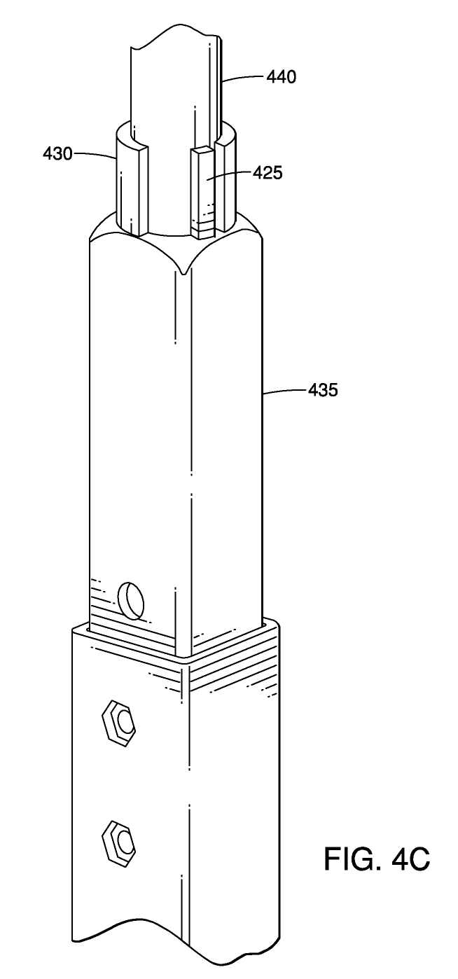

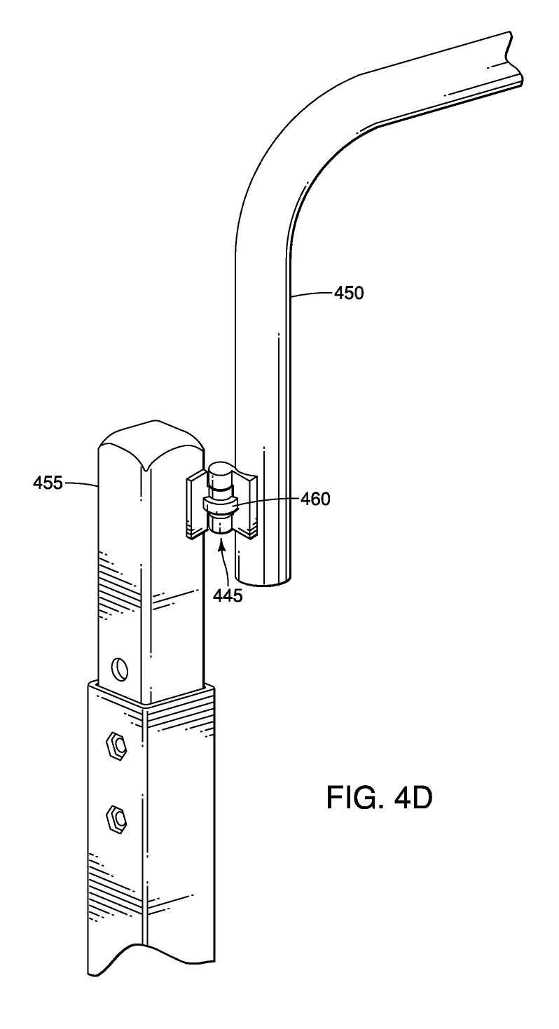

In an embodiment, the rotation of the grab bar 105 may be entirely or substantially restricted. For example, if another key is inserted on another side of the sleeve (as illustrated in FIG. 4A) or the slot 240 in the grab bar portion 215 inserted into the sleeve 110 is made sufficiently small in width, the range of rotational movement of the grab bar 105 may be substantially zero degrees.

In other embodiments, other keys may be used to restrict the rotation of the grab bar 105. Some exemplary keys include those available from McMaster-Carr® and having part numbers 1226BA51, 12265A53, 80625A32, 80625A34, 12265A55, 12265A57, 80625A36, 80625138, and other similar keys may be affixed to the sleeve 110 to engage with the grab bar 105 to restrict its rotation.

FIG. 2C illustrates another embodiment of a support device according to aspects of the subject matter described herein. In this embodiment, the grab bar 245 may attach to the sleeve 250 (which may no longer have a hole therein to receive the grab bar 245) through the use of a hinge 255 that allows the grab bar 245 to rotate. The hinge 255 may utilize a pin (similar to that shown in FIG. 2D) to allow the grab bar 105 to be decoupled from the sleeve 110

FIG. 2D illustrates an exemplary hinge for coupling a grab bar to a sleeve according to aspects of the subject matter described herein. In one embodiment, the hinge 265 may not allow for easy removal of the grab bar from the sleeve. In this embodiment, the pin 260 securing the hinge 265 may need a special tool, sufficient strength, or expertise to be removed. In another embodiment, the hinge may include a hidden pin 260 that is not readily discernable to a person with dementia or the like. This may be used to make it more difficult for such a person to decouple the grab bar from the sleeve.

FIG. 2E illustrates another exemplary hinge for coupling a grab bar to a stand. By lifting up the leaf 275 of the hinge 270, the leaves of the hinge 275 may be separated. By attaching a grab bar to the leaf 275, a stable support device with an easily removed grab bar may be constructed.

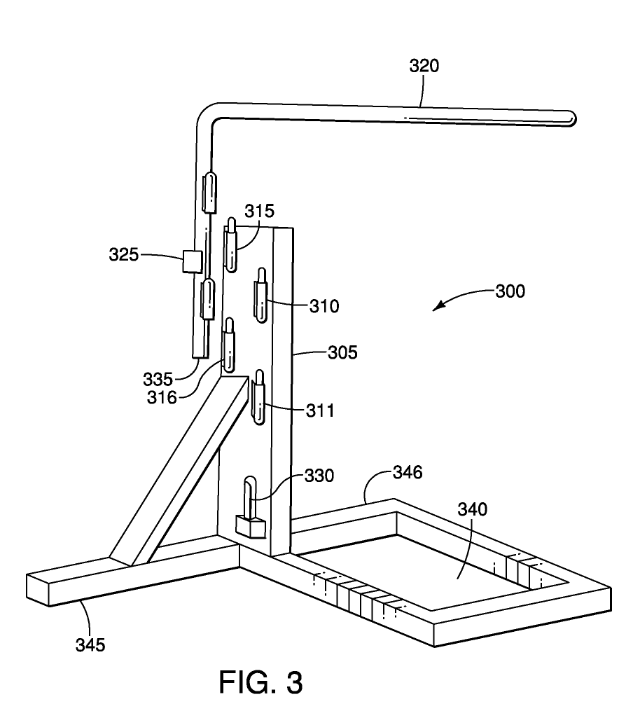

FIG. 3 illustrates another embodiment of a supporting device according to aspects of the subject matter described herein. In this embodiment, the stand 305 may be welded into a set configuration. The stand 305 may include multiple sets of bottom leaves (e.g., bottom leaves 310 and 311 and bottom leaves 315 and 316) to allow for more than one grab bar 320 to be attached to the stand simultaneously or to allow a height adjustment of the grab bar 320. The grab bar 320 may have a rotation stop 325 that restricts the rotational movement of the grab bar 105. In addition, the stand 305 may have a grab bar storage attachment 330 for storing the grab bar 320 when not in use. The grab bar 320 may have a hole in the end 335 allowing the grab bar 320 to be placed on the grab bar storage attachment 330.

The supporting device 300 may include a surface 340 upon which a foot of a bed may be placed. This may be done, for example, to increase the stability and decrease the lateral and tipping movement of the supporting device 300. The support legs 345 and 346 may also provide additional stability.

Turning to FIG. 4A, as described previously, the keys 235 and 405 may be used to restrict the rotational movement of the grab bar 105 to substantially zero degrees or some other range of rotation.

FIG. 4B illustrates another example of a mechanism that may be used to restrict rotational movement of the grab bar in accordance with aspects of the subject matter described herein. A structural member 410 having cutouts 415 and 420 may be formed to slide within the sleeve 110 at either of two orientations. The range of rotation for the grab bar 105 may be changed depending on the width of the cutouts 415 and 420 and the width of the slot 240 on the grab bar 105. To quickly change between two different ranges of rotation, the structural member 410 may be removed from the sleeve 110 and turned over such that the other cutout engages the edges of the slot 240 of the grab bar 105.

FIG. 4C illustrates another example of a mechanism that may be used to restrict rotational movement of the grab bar in accordance with aspects of the subject matter described herein. The grab bar 440 may have a rotation stop 425 attached thereto that engages with a collar 430 attached to the sleeve 435. When the rotation stop 425 engages with a side of the collar 430, it stops the rotation of the grab bar 440 in that direction. In an embodiment, the gap of the collar 430 may be fixed at construction time to determine the rotational range of the grab bar 440. In another embodiment, the gap of the collar 430 may be varied dynamically after construction (e.g., through pins, cutouts, or the like) to change the rotational range of the grab bar 440. In various embodiments, the grab bar 440 may have a slot similar to the slot 240 of FIG. 2B.

FIG. 4D illustrates another example of a mechanism that may be used to restrict rotational movement of the grab bar in accordance with aspects of the subject matter described herein. A hinge 445 that couples the grab bar 450 to the sleeve 455 may have a rotation stop 460 that restricts rotation of the grab bar 450 to a certain range of rotation. The grab bar 450 may rotated on the hinge 445 until it engages with the rotation stop 460 at which point it may rotate no further in that direction. The rotational range of the grab bar 105 may be varied by changing the dimensions of the rotation stop 460 as appropriate.

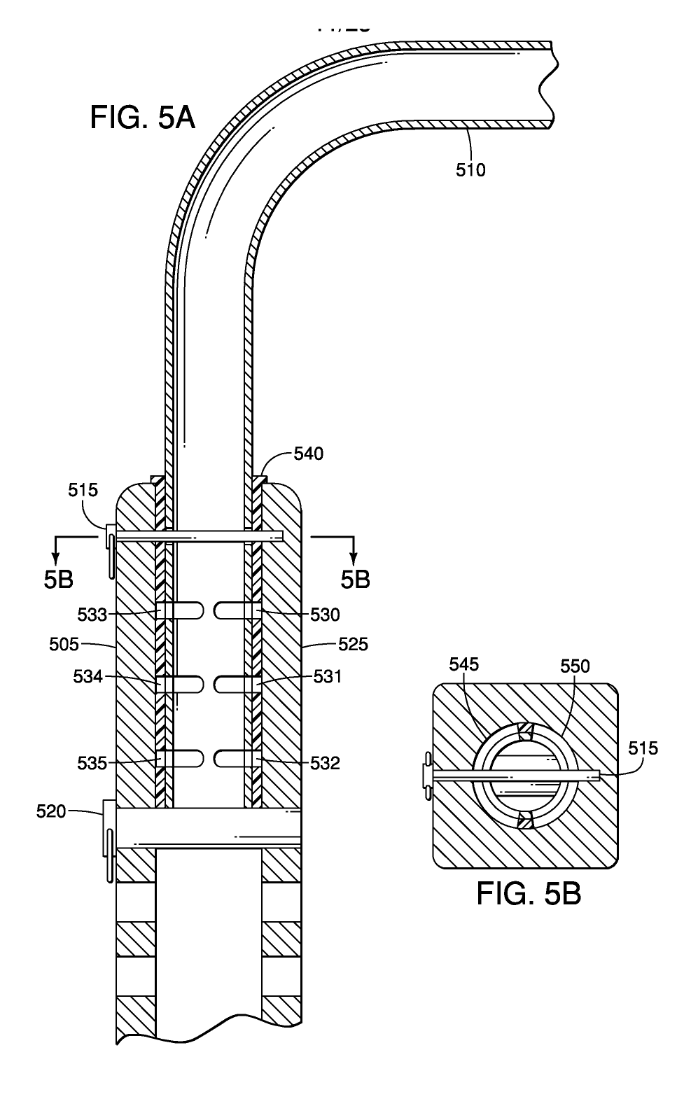

FIG. 5A is a view illustrating another embodiment of a mobility support device in accordance with aspects of the subject matter described herein. In an embodiment, the sleeve (e.g., sleeve 110 of FIG. 1) is replaced with a heavy gauge tubing 505 (hereinafter sleeve 525) that is part of the stand used to receive and support the grab bar 510.

In an embodiment, a pin 515 may be inserted through both sides of the sleeve 525 and through a groove in the grab bar 510. The radial dimensions of the groove determine the rotational range of the grab bar 510. In addition, the pin 515 provides additional support for keeping the grab bar 510 in the sleeve 110.

In another embodiment, the pin 515 may not extend all the way through both sides of the grab bar 510. Rather the pin 515 may extend into one side of the grab bar 510. In this embodiment, the rotational range of the grab bar 510 may also be increased or decreased by changing the radial size of the groove.

The bottom of the grab bar 510 may rest on a surface created by the pin 520. The sleeve 525 may have multiple holes in the side thereof sized to fit the pin 520. By moving the pin 520 to various of the holes, the height of the grab bar 510 may be changed.

The grab bar 510 may have multiple grooves 530-535 to allow for changing the height of the grab bar 510 so that the pin 515 may be reinserted into the grab bar 510 after the height has been changed.

The sleeve 525 may have a rubberized liner 540 or some other resistive surface to provide additional resistance to rotational and vertical movement of the grab bar 510.

FIG. 5B is a cross-sectional view taken along the line 5B-5B of FIG. 5A. As shown, the two grooves 545 and 550 may extend around the grab bar to provide rotational range for the grab bar 510 when the pin 515 is inserted through the grab bar 510.

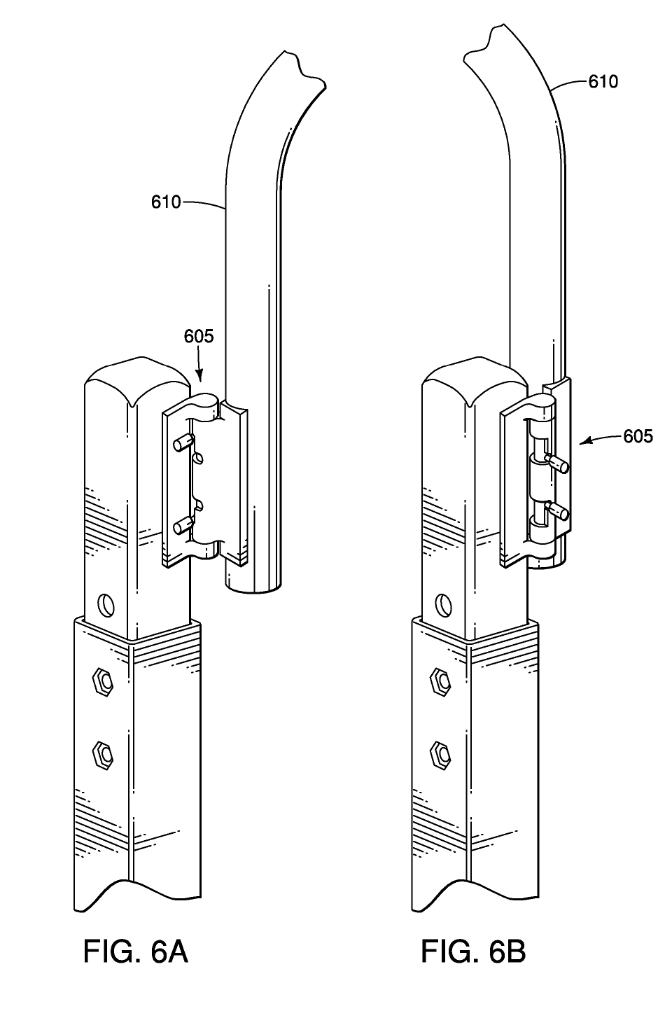

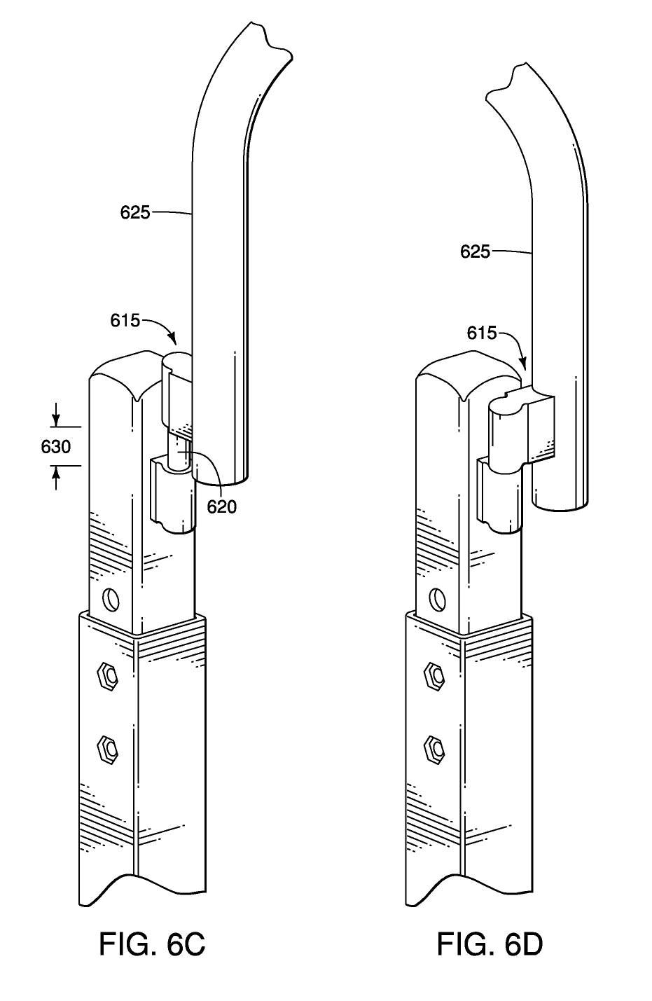

FIGS. 6A and 6B are views that illustrate a mobility device having a bi-stable hinge in accordance with aspects of the subject matter described herein. With springs or other suitable mechanisms, the hinge 605 is structured to have two stable resting points. When the grab bar 610 is rotated away from one of the resting points, the mechanism provides a restoration force that tends to rotate the grab bar 610 back to the resting point to which it is closest. For example, it may be desired to have one resting point correspond to having the grab bar 610 parallel to the bed and another resting point correspond to having the grab bar 610 perpendicular to the bed. In this embodiment, after a person releases the grab bar after use, the grab bar 610 tends to come to rest either next to the bed or next to the wall.

By appropriately sizing the restoration mechanism, the restoration force may be adjusted to be stronger or weaker as desired. In other embodiments, if available, a hinge with one, three, or more stable resting points may be substituted for the hinge 605.

FIGS. 6C and 6D are views that illustrate a gravity hinge that tends to restore the grab bar to a single resting point after being released in accordance with aspects of the subject matter described herein. The hinge 615 may be formed using an inclined ramp around the pin 620 such that by rotating the grab bar 625, potential energy is transferred to the grab bar 625 in the form of the grab bar 625 having a greater height. When the grab bar 625 is released, gravity may then pull the upper portion of the hinge 615 down the inclined ramp to return the grab bar 625 to a resting point where the upper portion of the hinge 6615 is at the bottom of the inclined ramp.

To this end, FIG. 6C shows the grab bar 625 in a position where the grab bar 625 has been rotated away from its resting point. This is indicated by the increased height of the grab bar 625 as well as the gap 630 between the lower and upper leaves of the hinge 615. FIG. 6D shows the grab bar 625 at its resting point. This is indicated by the lowered height (with respect to FIG. 6C) of the grab bar 625 as well as the absence of a gap between the leaves of the hinge 615.

In an embodiment, the hinge 615 may be fitted with a mechanism that restricts rotation past the top of the incline. This may be done to avoid an abrupt drop of the grab bar 625 as the bar is rotated up the inclined ramp until it falls back to the no-gap position.

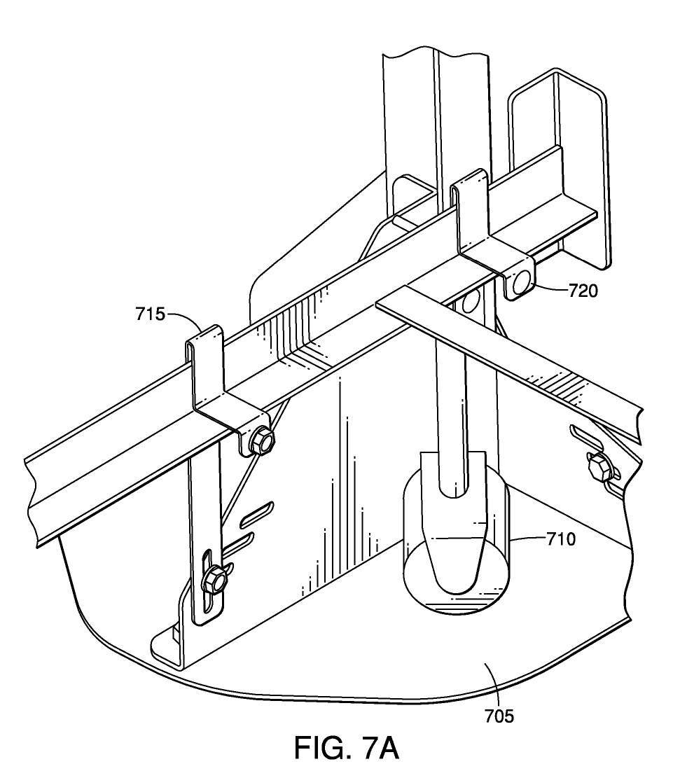

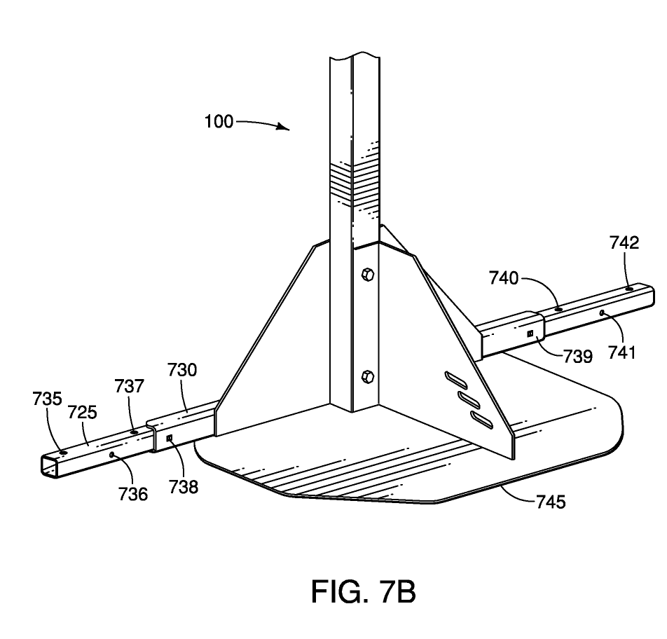

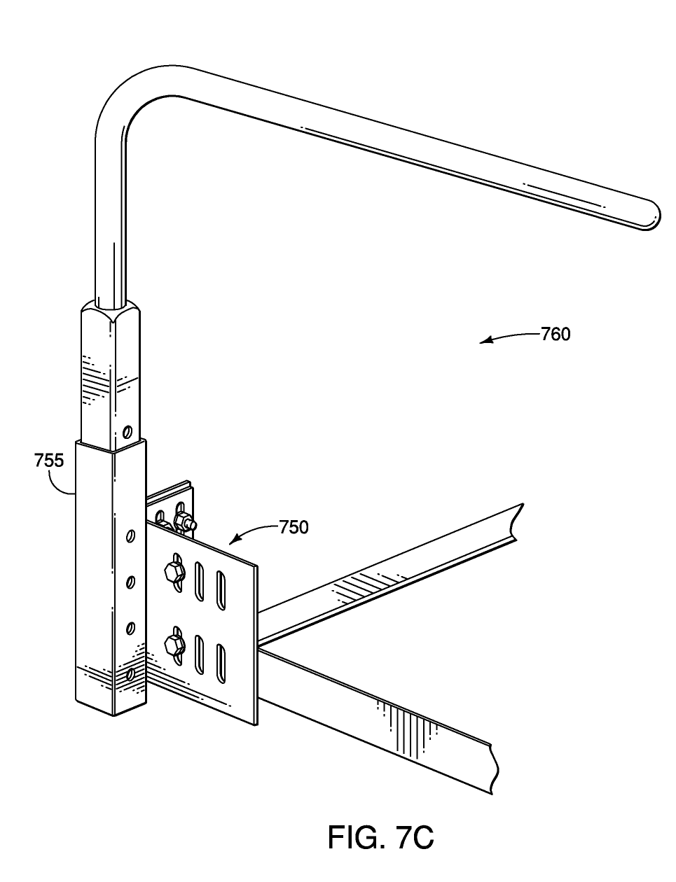

FIGS. 7A-7C are views that illustrate various embodiments in which additional stability may be provided to the support device in accordance with aspects of the subject matter described herein. Turning to FIG. 7A, the base of a support device may have a surface 705 constructed to rest under a foot 710 the bed. If the foot 710 the bed is at another location on the bed such that it does not rest on the surface 705, a “false” foot may be attached to the bed frame and placed upon the surface 705. In this manner, the weight of the bed may assist in providing stability to the support device.

In addition, other structural members 715 and 720 may be formed to wrap around the bed frame. These other structural members 715 and 720 may be attached to the support device through bolts and nuts, for example.

Turning to FIG. 7B, a support leg 725 may slide within a support sleeve 730. The support leg 725 may be positioned depending on which side of the bed the support device 100 is positioned. To hide the support leg 725 from view, for example, the support leg 725 may be slid under the bed. Once the support leg 725 is positioned at a desired location, the support leg 725 may be fixed in place by bolts, pins, or the like passing through the support sleeve 730 into the support leg 725. Screws may pass through the holes 735-742 and into a structural framing member of a wall (e.g., a plate) or floor to firmly affix the support leg to a particular location and provide added stability to the support device 100.

In addition to, or in lieu of, attaching the support leg to the wall or floor, the base plate 745 may be screwed into the floor at various locations to provide additional stability to the support device.

Turning to FIG. 7C, to attach directly to odd-sized beds or movable beds including hospital beds, an attachment member 750 may be used. The attachment member 750 may be attached to the stand 755. In an embodiment, the support device 760 may not have a base member to attach the support device to the floor or wall. Rather, the support device 760 may be secured to the bed through the attachment member 750 only. In this manner, the support device 760 may move with the bed which may be particularly helpful for hospital beds and other mobile beds, for example.

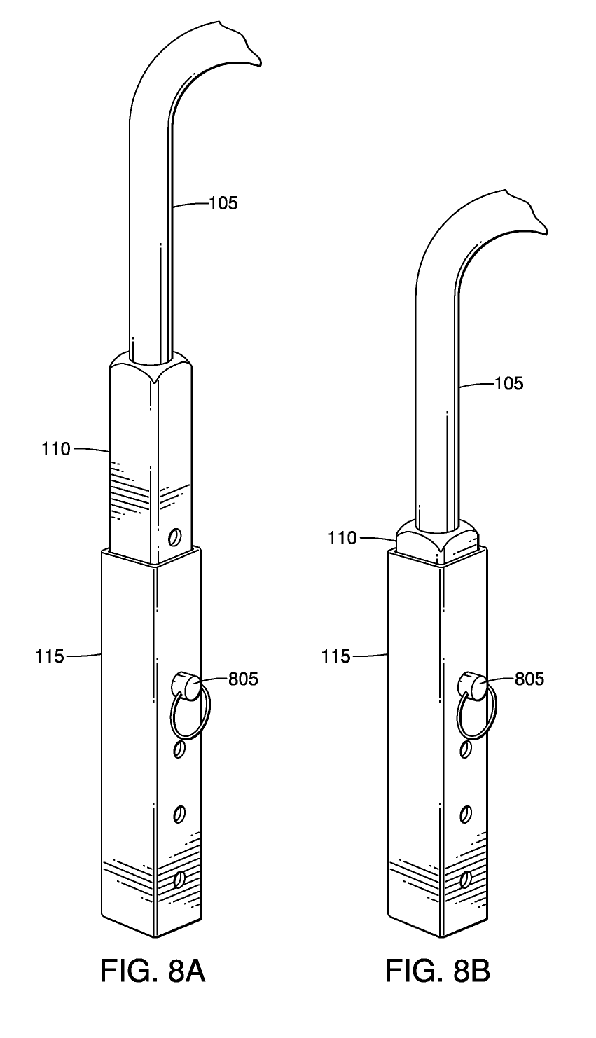

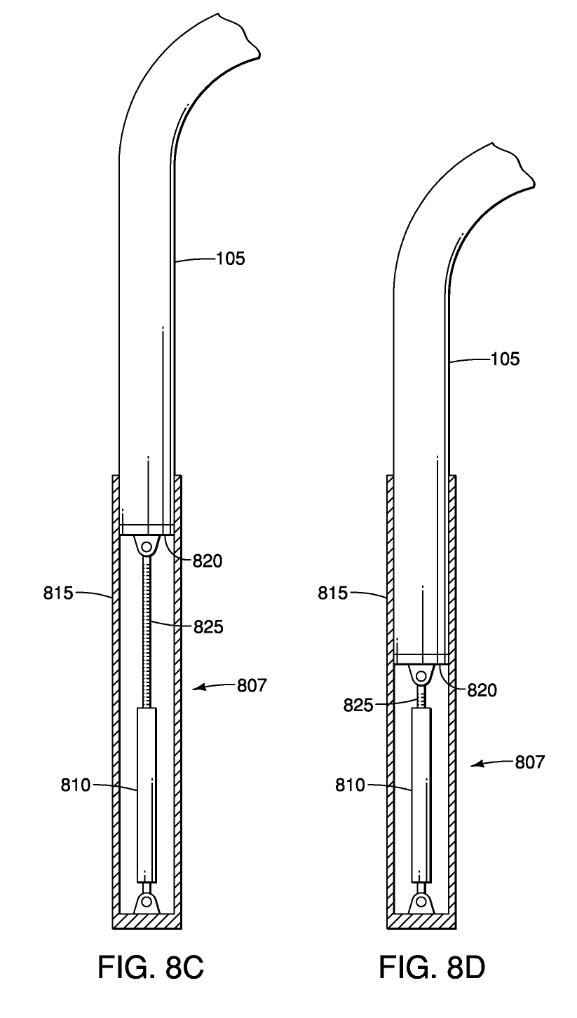

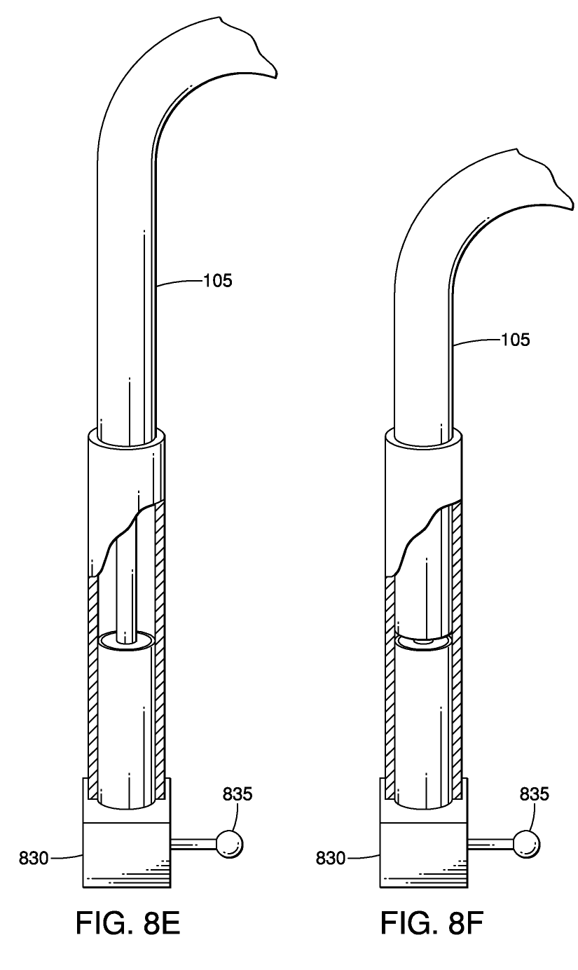

FIGS. 8A-8F are views that illustrate exemplary embodiments for adjusting the height of the grab bar in accordance with aspects of the subject matter described herein. Turning to FIGS. 8A and 8B, the sleeve 110 and stand 115 may have holes that allow a pin 805 to be inserted therein. By removing the pin 805, the height of the sleeve 110 may be adjusted by aligning holes within the stand 115 with holes within the sleeve 110. After the desired height is found, the pin 805 may be reinserted into the stand 115 and sleeve 110 to fix the height of the grab bar 105.

Turning to FIGS. 8C and 8D, a screw mechanism 807 may be inserted into the sleeve 815 to provide a surface 820 upon which to rest the bottom edge of the grab bar 105. To adjust the height of the grab bar 105, the screw mechanism 807 may be removed from the sleeve 815 and lengthened or shortened by rotating the screw 825 while holding the screw sleeve 810 fixed. The screw mechanism 807 may then be reinserted into the sleeve 815 and the grab bar 105 placed thereon to change the height.

In FIGS. 8E and 8F, a hydraulic mechanism 830 may raise or lowers a surface upon which the bottom edge of the grab bar 105 rests to change the height of the grab bar 105. The hydraulic mechanism 830 may include a lever 835, switch, or the like to cause lowering or raising.

In an embodiment, the hydraulic mechanism 830 may form a stand or be placed at the bottom of the stand into which a sleeve such as the sleeve 110 of FIG. 1 may be placed. In this embodiment, the hydraulic mechanism 830 may raise or lower the receiving surface of the stand to raise or lower the height of the sleeve and consequently the grab bar 105.

In other embodiments, a pneumatic or electric mechanism may be substituted in place of the hydraulic mechanism 830 to raise or lower the grab bar 105.

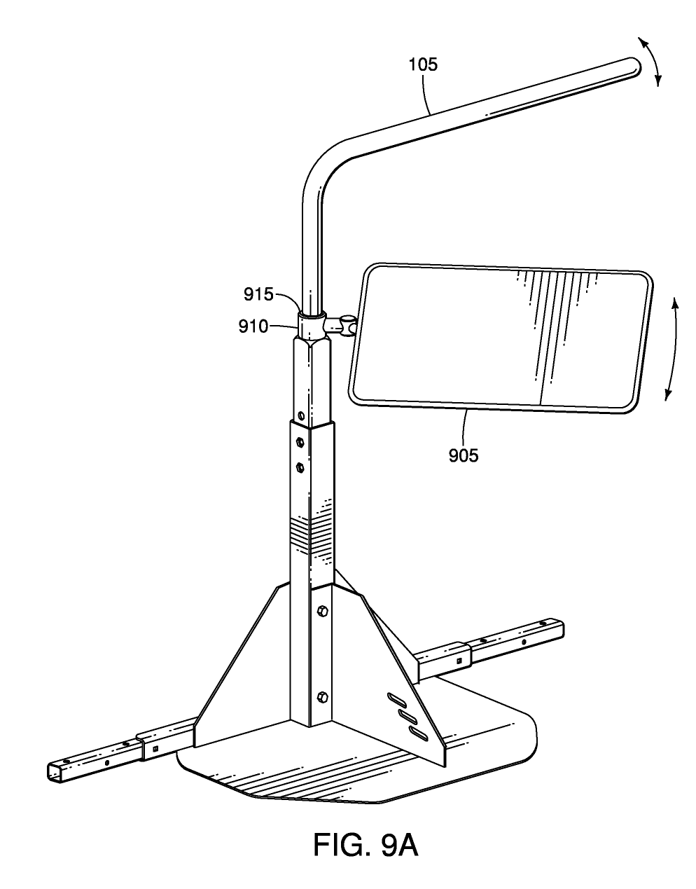

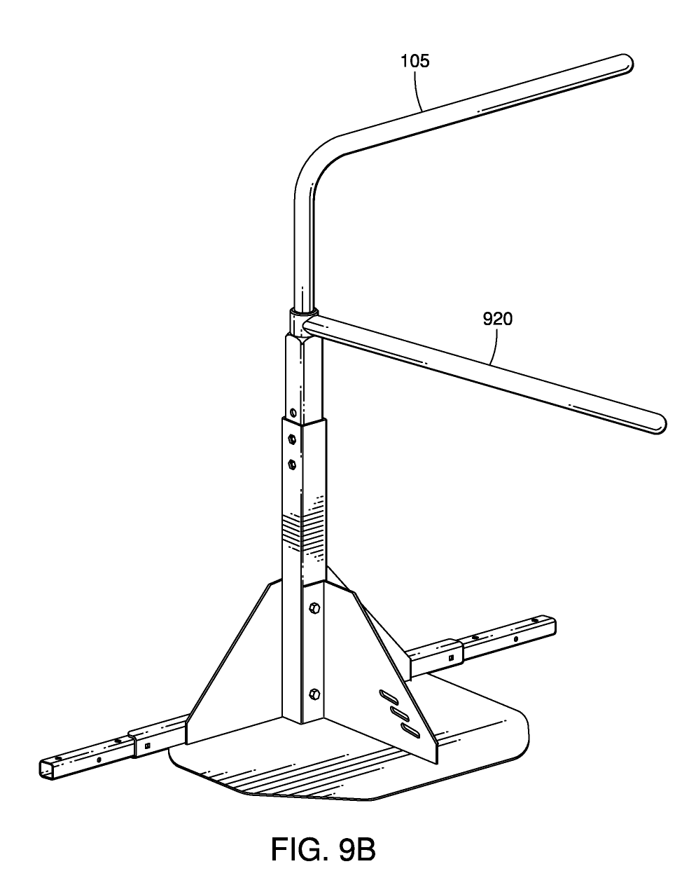

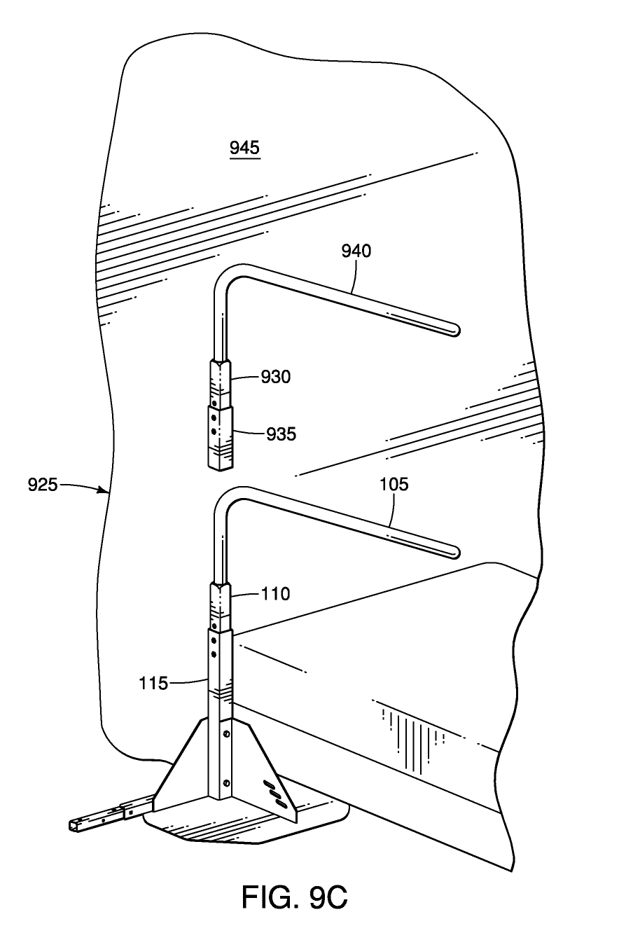

FIG. 9A illustrates a support device that includes a table and a grab bar in accordance with aspects of the subject matter described herein. The table 905 may include a collar 910 that slips over a sleeve collar 915 that receives the grab bar 105. The table 905 and the grab bar 105 may rotate independently of each other and may have the same or different ranges of rotation. The grab bar 105 may operate as described previously with respect to single grab bar embodiments in allowing for height adjustment, easy removing of the grab bar, restriction of rotation of the grab bar, and so forth.

FIG. 9B illustrates a two bar embodiment of a support device in accordance with aspects of the subject matter described herein. The grab bars 105 and 920 operate as described above in conjunction with FIG. 9A with one of the bars taking the place of the table 905. As described previously in conjunction with FIG. 3, in another embodiment, the hinge structure of FIG. 3 may also be used to provide support for two bars at different heights.

FIG. 9C illustrates another two bar embodiment of a support device in accordance with aspects of the subject matter described herein. The support device 925 may have a first sleeve 110 and stand 115 that provides support for a first grab bar 105 at a first height. The support device 925 may also have a second sleeve 930 inserted into a stand 935 that is secured to a wall 945 via screws, bolts, or other fasteners at a height different than the first stand 115. Together, the sleeves 930 and 110 and stands 935 and 115 allow two grab bars 105 and 940 to assist a person in getting into or out of bed or maneuvering thereon. Each of the sleeves 110 and 930 cooperating with the stands 115 and 935, respectively, may function as described previously with respect to single grab bar embodiments in allowing for height adjustment, easy removing of the grab bar, restriction of rotation of the grab bar, and so forth.

In another embodiment, a plurality of hinge leaves similar to the bottom leaves 310, 311, 315, and 316 of FIG. 3 may be mounted on the wall. A grab bar suitable for use with these hinges may be used for mobility support.

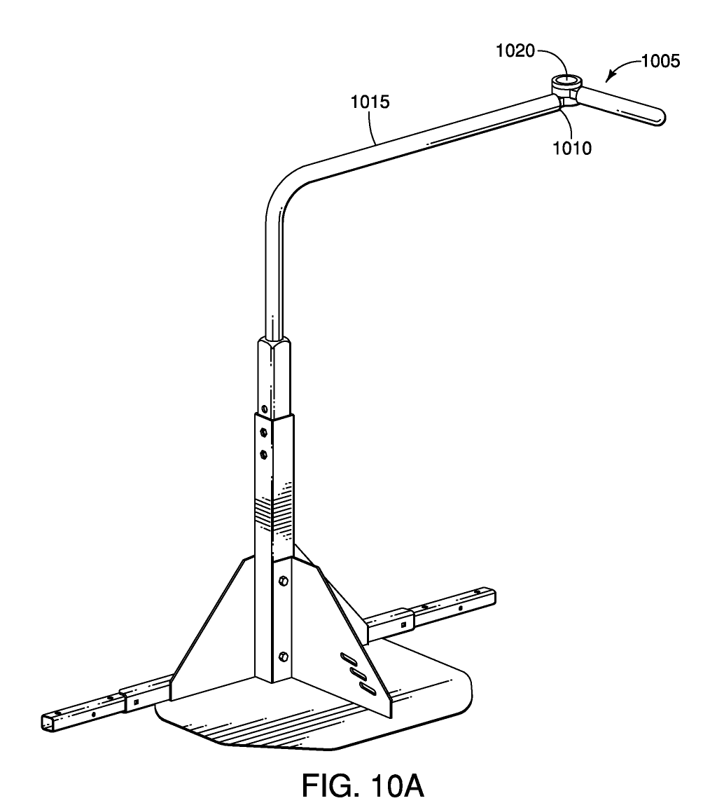

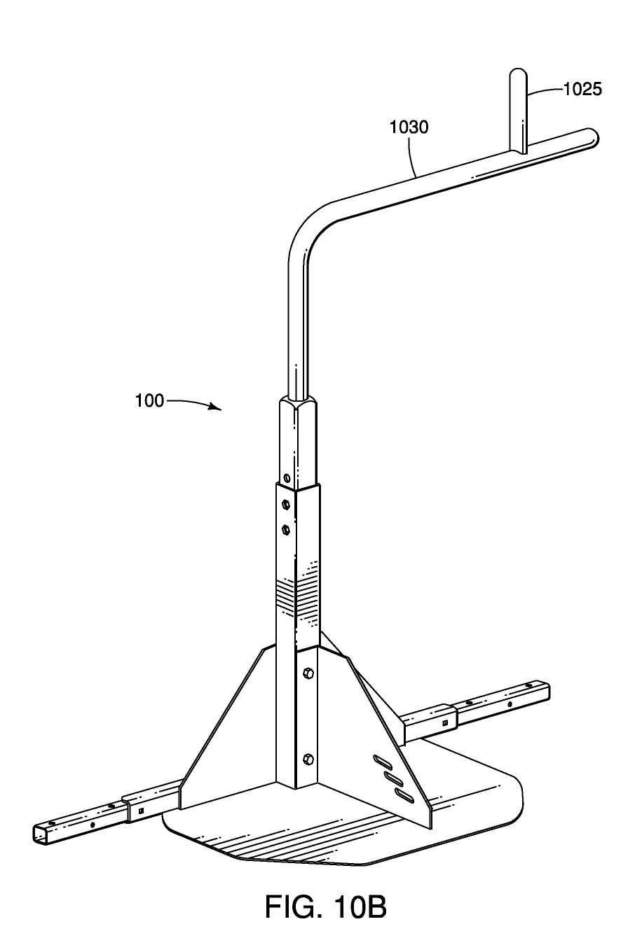

FIG. 10A illustrates a grab bar embodiment in accordance with aspects of the subject matter described herein. Turning to FIG. 1A, an adjustable extension 1005 may be inserted into the end 1010 of the grab bar 1015. The adjustable extension 1005 may rotate at fixed increments about a point 1020 of rotation such that the adjustable extension 1005 tends to remain at an angle of rotation until sufficient force is applied to move the adjustable extension 1005 to another angle. One exemplary embodiment of a hinge allowing fixed increments is described in U.S. Pat. No. 5,662,596 to David Ernest Young, entitled “TRUE BI-PIVOTAL ORTHOPEDIC AND ORTHOTIC HINGE WITH INCREMENTAL MOTION CONTROL,” which patent is hereby incorporated by reference with regards to its teachings regarding this hinge.

Alternatively, a button, pin, or the like, may lock the adjustable extension 1005 at a particular angle. Until the button is depressed, the pin removed, or some other action is taken to unlock the adjustable extension 1005, the angle may remain fixed. After this action occurs, the angle of the adjustable extension 1005 may be changed until the button, pin, or the like is again used to lock the angle of the adjustable extension 1005.

The adjustable extension 1005 may comprise a tube that is inserted into the grab bar 1015. The adjustable extension 1005 may be secured to the grab bar 1015 through a pin, bolt, or the like. The adjustable extension 1005 may have holes in the tube through which the pin may be inserted to vary the extension length of the adjustable extension 1005.

FIG. 10B illustrates another grab bar embodiment in accordance with aspects of the subject matter described herein. The grab bar 105 may include a handle 1025 that extends perpendicular to the length of the grab bar 1030. This handle 1025 may provide additional support for people using the support device 100 for mobility support.

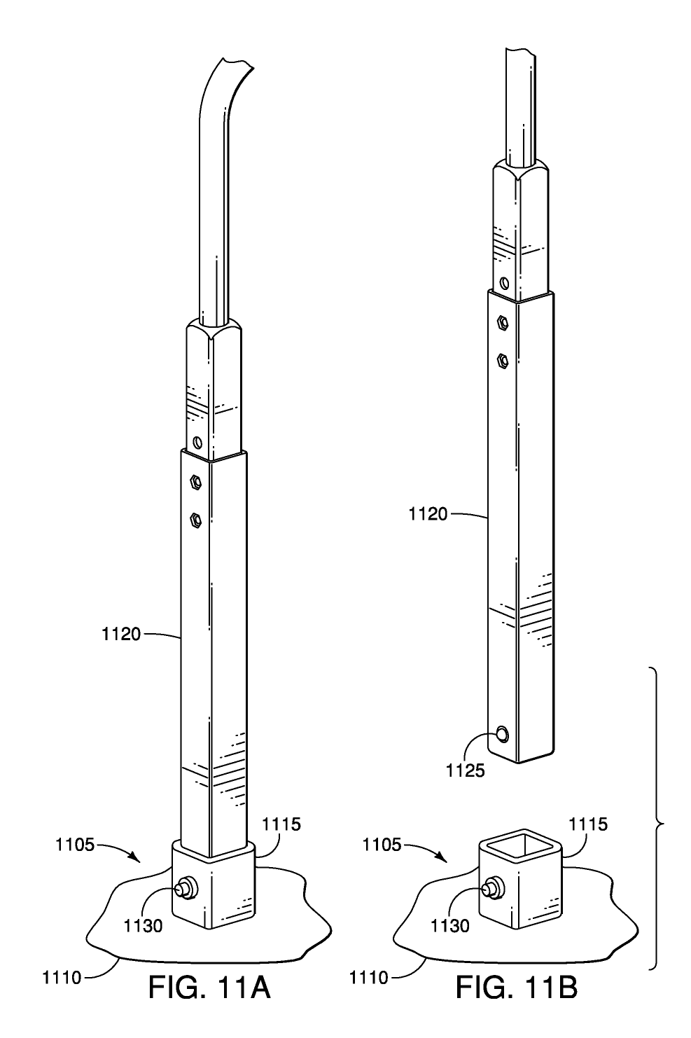

FIGS. 11A and 11B illustrate an exemplary docking base according to aspects of the subject matter described herein. The docking base 1105 may be secured to a floor 1110 and have a sleeve 1115 to receive a stand 1120. The stand 1120 may include a spring-loaded ball 1125 that engages with a hole in the sleeve 1115 to secure the stand 1120 to the sleeve 1115. To remove the stand 1120 from the sleeve 1115, a button 1130 may be pressed which pushes the ball 1125 into the interior of the stand 1120 and disengages the ball 1125 from the hole.

It will be recognized by those skilled in the art that many other quick-release mechanism may be used as a docking base to obtain the function described above. In one embodiment, for example, a docking base may be installed such as to be substantially flush with the floor surface. For example, a plate having an appropriate sized sleeve may be fastened to the floor. A lever or button on the stand may be used to disengage the stand from the sleeve. A cap may be placed on the sleeve of the docking base when it is not supporting a stand for aesthetics or safety, for example.

As another embodiment, struts may be fastened to the floor and the stand may have components to slide into the struts and to fix the location of the stand. Some exemplary struts and associated hardware that may be used in this way are available as part numbers 3533T*, 3545T*, 3190T*, 32525T*, and 1819T* from McMaster-Carr® where “*” stands for one or more other alphanumeric characters. These parts are shown on page 1400 of a catalog available from McMaster-Carr® at the time of the filing of this application. In an embodiment, fixing the location of the components that slide into the strut may be performed by rotating one of the components and/or the entire stand after sliding the component into the strut. This rotation may lock the component at a fixed location within the strut.

As can be seen from the foregoing detailed description, aspects have been described related to providing mobility support. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A device for assisting a person to maneuver, the device comprising:
a support structure having an upper end and a lower end, wherein the lower end is coupled to a base for securing the support structure in an upstanding position; and
a pivotable grab bar coupled to the support structure, wherein the pivotable grab bar includes a first portion that extends substantially upward from the support structure and a second portion that extends at an angle from the first portion, wherein the pivotable grab bar is structured to be decoupled from the upper end of the support structure when a substantially vertical force is applied to the first portion of the pivotable grab bar, and wherein the pivotable grab bar is structured to resist decoupling from the upper end of the support structure when a horizontal component of force is applied to the first portion of the pivotable grab bar.

2. The device of claim 1, wherein the support structure comprises a sleeve adapted to receive at least part of the first portion of the pivotable grab bar and to allow the pivotable grab bar to rotate within the sleeve.

3. The device of claim 2, wherein the sleeve comprises a structural member having a circular hole formed therein of a first diameter, wherein the first portion of the pivotable grab bar comprises a tube having an outer diameter of a second diameter, wherein the first diameter is larger than the second diameter such that gravity on the second portion of the pivotable grab bar causes the first portion of the pivotable grab bar to sit at a slight angle with respect to the sleeve.

4. The device of claim 2, wherein the sleeve is coated with a rubberized liner structured to provide additional resistance to rotational and vertical movement of the pivotable grab bar.

5. The device of claim 1, wherein the pivotable grab bar is coupled to the support structure via a hinge.

6. The device of claim 5, wherein the hinge includes a restoration component adapted to exert a force on the pivotable grab bar to cause the pivotable grab bar to pivot toward a resting state.

7. The device of claim 6, wherein the restoration component comprises a spring mechanism having at least two stable resting states.

8. The device of claim 6, wherein the restoration component comprises a ramp adapted to cause the pivotable grab bar to gain potential energy when the pivotable grab bar is rotated in a first direction.

9. The device of claim 5, wherein the hinge comprises a rotation stop structure adapted to restrict movement of the hinge to a range of rotation.

10. The device of claim 1, further comprising a key and wherein the first portion of the pivotable grab bar comprises a slot adapted to engage the key to restrict rotational movement of the pivotable grab bar.

11. The device of claim 1, wherein the support structure comprises a height adjustment component adapted to raise or lower a height at which the pivotable grab bar rests.

12. The device of claim 11, wherein the height adjustment component comprises a pneumatic, hydraulic, or electric component.

13. The device of claim 11, wherein the height adjustment component comprises a pin adapted to be inserted through holes within the support structure.

14. The device of claim 1, wherein the base is attached to a bed frame via a component that wraps around a portion of the bed frame.

15. The device of claim 1, wherein the base includes a surface structured to support a foot of a bed to provide additional stability to the base.

16. The device of claim 1, further comprising a support leg coupled to the base, wherein the support leg has holes therein to attach the support leg to a wall or floor via fasteners.

17. The device of claim 1, further comprising a second pivotable grab bar coupled to the support structure, wherein the second pivotable grab bar is at a different height than the pivotable grab bar, and wherein the second pivotable grab bar is structured to rotate independently of the pivotable grab bar.

18. The device of claim 1, further comprising a pivotable table coupled to the support structure, wherein the pivotable table is structured to rotate independently of the pivotable grab bar.

19. The device of claim 1, wherein the support structure is coupled to the base via a removable coupling that allows the support structure to be decoupled from the base.

20. The device of claim 19, wherein the removable coupling is arranged to decouple the support structure from the base via a button.

21. A method for assisting a person to maneuver, the method comprising:
placing a support structure at or near a head of a bed; and
coupling a grab bar to the support structure, wherein the grab bar includes a first portion and a second portion that are at an angle with respect to each other, wherein the grab bar is structured to decouple from the support structure when a substantially vertical force is applied to the first portion of the grab bar, and wherein the grab bar is structured to resist decoupling from the support structure when a horizontal force is applied to the first portion of the grab bar.

22. The method of claim 21, further comprising securing the support structure.

23. The method of claim 21, wherein the support structure comprises a base and wherein securing the support structure comprises fastening the base into a floor beneath the base.

24. The method of claim 21, wherein the support structure comprises a support leg and wherein securing the support structure comprises fastening the support leg into a wall next to the base.

25. The method of claim 21, wherein the support structure comprises a base, and wherein securing the support structure comprises placing a foot of the bed on the base.

26. The method of claim 21, wherein securing the support structure comprises connecting the support structure to a docking station.

27. The method of claim 21, wherein securing the support structure comprises connecting the support structure to a frame of the bed.

28. The method of claim 21, wherein applying a substantially vertical force to the first portion of the grab bar comprises applying a substantially vertical force to the second portion of the grab bar at a location near the first portion.

29. The method of claim 21, wherein applying a horizontal component of force to the first portion of the grab bar comprises applying a vertical force to the second portion of the grab bar at a location distal from the first portion of the grab bar.

30. A system for assisting a person to maneuver, the system comprising:
a bed having a surface adapted to support a weight of a person; and
a support device structured to be placed next to the bed to provide support to the person in manuevering related to the bed, the support device including a pivotable grab bar, wherein the pivotable grab bar is structured to decouple from the support device when an upward force that tends to pull the pivotable grab bar substantially vertical is greater than friction and weight forces associated with the pivotable grab bar.

31. The system of claim 30, wherein the manuevering comprises getting into and out of the bed.

32. The system of claim 30, wherein the manuevering comprising rolling over in the bed.

33. The system of claim 30, wherein the bed comprises a mobile bed and wherein the support device is connected to the bed such that the support device moves with the bed.

34. The system of claim 30, wherein the support device is fastened to a wall or floor.
